(19) United States
(12) Patent Application Publication
(10) Pub. No.: US 2026/0227685 A1
(43) Pub. Date: Aug. 6, 2026

(54) IMAGE PROJECTOR

(71) Applicant: Canyon Product Development, LLC, Nashville, TN (US)

(72) Inventor: Michael Kevin McKervey, Nashville, TN (US)

(73) Assignee: Canyon Product Development, LLC, Nashville, TN (US)

(21) Appl. No.: 19/459,522

(22) Filed: Jan. 26, 2026

Related U.S. Application Data
(63) Continuation-in-part of application No. 19/440,084, filed on Jan. 5, 2026, now abandoned.
(63) Continuation-in-part of application No. 18/079,678, filed on Dec. 12, 2022, now Pat. No. 12,535,725.
Application No. 19/440,084 is a continuation of application No. 18/079,678, filed on Dec. 12, 2022, now Pat. No. 12,535,725.
(60) Provisional application No. 63/289,466, filed on Dec. 14, 2021.

(51) Int. Cl. G03B 21/28; G03B 21/14

(52) U.S. Cl. CPC G03B 21/28; G03B 21/142

(57) ABSTRACT

In an illustrative embodiment, methods and systems for image projection include a beam source configured to generate a source beam, a beam diverter configured to modify propert(ies) of each beam of a beam profile created from the source beam according to a configuration selection, and a multiple beam director disposed in a path of the beam profile, the multiple beam director having a physical structure including surface features configured to modify the beam profile to produce at least one encoded image. The multiple beam director may be configured to, when the beam profile strikes the multiple beam director, selectively alter the beam profile according to the propert(ies) of each light beam, thereby producing a light beam image pattern configured to present, upon striking one or more projection surfaces, at least a portion of at least one image.

### RELATED APPLICATIONS

This application is a continuation-in-part of and claims priority to U.S. patent application Ser. No. 19/440,084 entitled “Image Projector” and filed Jan. 5, 2026, and Ser. No. 18/079,678, entitled “Image Projector” and filed Dec. 12, 2022. U.S. patent application Ser. No. 19/440,084 is a continuation of U.S. patent application Ser. No. 18/079,678 entitled “Image Projector” and filed Dec. 12, 2022, which claims priority to U.S. Provisional Patent Application Ser. No. 63/289,466, entitled “Laser Based Image Projector,” filed Dec. 14, 2021.

This application is related to the following prior patent application: U.S. patent application Ser. No. 15/635,791, entitled “Image Projector,” filed Jun. 28, 2017 (now U.S. Pat. No. 10,694,158).

Each of the above identified applications is hereby incorporated by reference in its entirety.

### BACKGROUND

During certain hazards, or in certain locations, it can be beneficial to project information about exits, emergency stations, or any other similar information onto the ground or other visible surfaces where it would not be desirable to present such information in a permanent fashion, such as via paint or permanently erected signs. One solution to this is to utilize a projection system to project the pertinent information or iconography on the desired surface only at the appropriate times.

Complex laser imaging systems, such as those utilized in projectors, include multiple complex mirrors, each of which is required to move in synchronization with each of the others mirrors in order to generate a desired image. Laser imaging systems typically include complex and delicate electronic and mechanical controls that control the synchronization of the mirrors. As a result of the significant number of colors and lasers utilized, as well as the delicate electronics within a projector, continued, uninterrupted, operation of the projector under hazard conditions, such as those that would be present in the case of a fire, flood, exposure to the elements, forces from transportation, or any similar hazard, is unreliable or impossible. The complex systems, and systems with a computer directing the beam paths, also may have more opportunity for malfunctions to direct a beam in an unintended manner, creating a hazard. These complex systems can also be heavy and consume a large amount of power.

### SUMMARY OF ILLUSTRATIVE EMBODIMENTS

The inventor recognized the need for a simple, low budget, durable projection solution for presenting an image, including letters, shapes, and/or other designs, to relay a message. Further, the projection solution may be low-power and light weight. The image, in some illustrative examples, can include a word, phrase, sentence, traffic symbol, safety symbol, navigational symbol, logo, mascot, graphical icon such as an emoticon, or other shape used to relay meaning to a viewer. The message intended by the image(s) projected by the projection solution may be designed, in some examples, for the benefit of passersby, drivers, or other people in an area. In other examples, the messages may be designed to relay information to animals or military personnel.

In some embodiments, projection solution projects one or more images that are completely or partially rendered in visible wavelengths The messages may be identifiable, at least in part, utilizing computerized equipment. For example, messages may be recognizable by equipment or machinery in a manner that does not necessarily involve the human-visible light spectrum (e.g., visible range typically being approximately 380 nm to 750 nm for humans). In illustration, self-driving vehicles such as cars and/or drones may be designed recognize projected messaging outside the wavelengths of human-visible light.

In one aspect, the present disclosure relates to projecting information by physically encoding at least one image into the surface geometry of a beam director (e.g., facets, openings, convex surfaces, concave surfaces, continuous 3D surfaces, non-continuous 3D surfaces, scattering surfaces, absorbing surfaces, reflective surfaces, diffractive surfaces, reflective surfaces, and similar elements). The image encoded into the beam director may be conveyed by directing at least one beam profile at the surface geometry of the beam director. A beam profile refers to a particular beam pattern, including beam spacing, beam size, and beam shape. The beam profile does not contain the image. The beam profile is incident across the beam director in one or more areas. The beam director is designed to redirect one or more specific beam profiles on the one or more areas of the beam director from one or more specific vectors onto one or more projection surfaces where the at least one image is displayed.

In some embodiments, the beam profile is created by the beam source. A non-exclusive example of this is the commonly available rectangular laser beam. The rectangular profile strikes the beam director. The beam director's geometry is such that the specific beam profile at the specific vector creates an image on a projection surface.

In some embodiments, the beam profile is created by directing a light beam through a beam profiler. The beam profiler, for example, may include shaped openings, mirrors, lenses, diffraction gratings, or other optical elements. A non-exclusive example of this is a cylinder lens, used to generate a narrow rectangle. The rectangular profile strikes the beam director. The beam director's geometry is such that the specific beam profile at that vector creates an image on a projection surface.

In some embodiments, the beam profiler is movable in relation to the beam director to cause controlled redirection of the light beam(s) off of the beam director and onto a projection surface as the beam profile is swept across the beam director, where the redirected light repeatedly traces out the image at a refresh speed allowing human recognition of the encoded image. The refresh speed, in one example, may be configured such that, to the human eye, the entire image is displayed at once. In another example, the refresh speed may be configured such that portions of the image are interpretable by the human eye at different times. For example, a first character or set of characters of a message may appear to be visible prior to other characters of the message. In another example the image may have gaps in the border which could be moving or stationary.

In some embodiments, the beam profile sweeps across multiple locations on the beam director to create multiple or moving images.

In one aspect, methods and systems of projecting an image include emitting a beam profile onto a beam director and redirecting the beam onto a projection surface using the beam director such that the beam forms the at least one image on the at least one projection surface. The beam director may include at least one image encoded onto the beam director.

In some embodiments, a beam profiler is used to create the beam profile. The beam profiler may project the beam profile onto the beam director for redirection to the at least one projection surface. The beam profiler may be an element which changes the profile of the beam projected on the beam director. The beam profiler may be a reflector. A beam may be incident on the beam profiler, which projects a beam profile onto the beam director. The beam profiler may be a refractor. A beam may be incident on the beam profiler, which projects a beam profile onto the beam director. The beam profiler may be a diffractor. A beam may be incident on the beam profiler, which projects a beam profile onto the beam director. The beam profiler may be articulating. A beam may be incident on the beam profiler, which when articulated traces a beam profile on to the beam director. Moving the beam profiler relative to the beam source may include rotating the beam profiler about an axis.

In some embodiments, the at least one image is encoded on the beam director via a shape and dimensions of at least one surface of the beam director.

In some embodiments, a redirection angle of the altered beam is dependent on a specific angle in three-dimensional space of an incident surface of the beam director, a location of the beam profile relative to the beam director, and a point of incidence of the beam profile on the beam director. Moving the beam profiler relative to the beam source may include moving the beam profiler linearly.

In some embodiments, the beam director includes an array of angled faces and locations where the beam profile is incident upon the beam director passes through the array of angled faces. A location of the beam on the projection surface may be at least partially controlled by an angle of a face of the beam director that the beam profile is incident upon relative to the beam.

In some embodiments, the beam source is continuously on as the at least one image is projected.

In some embodiments, the beam source is cycled between an on state and an off state as the at least one image is projected. The beam source, for example, may be cycled between an on state and an off state as the at least one image is traced.

In some embodiments, movement of the beam profiler is cyclical. Movement of the beam profiler may undergo at least 24 cycles per second.

In some embodiments, moving the beam profiler includes at least one of rotating the beam profiler about an axis or moving the beam profiler linearly.

In one aspect, an imaging device includes a beam source configured to produce a beam profile, and at least one beam director including at least one encoded image, where the beam profile is incident upon a surface of the at least one beam director, and the beam is redirected by the at least one beam director onto a projection surface, such that the beam projects the at least one encoded image on a projection surface.

In some embodiments, a beam profiler is used to create the beam profile. The beam profiler may project the beam profile on the beam director for redirection to the at least one projection surface. The beam profiler may be an element which changes the profile of the beam to project a beam profile on the beam director. The beam profiler may be an articulating. A beam may be incident on the beam profiler, which when articulated traces a beam profile on to the beam director. The beam profiler actuator may be a rotary actuator.

In some embodiments, the at least one encoded image is encoded on the at least one beam director via a shape and dimension of the surface of the at least one beam director.

In some embodiments, the at least one surface of the at least one beam director includes a multitude of faces.

In some embodiments, the beam profiler actuator is a linear actuator, and the at least one beam director includes a clear structure having an incident surface and a refraction surface, where each of the refraction surface and the incident surface are at varied angles relative to the beam.

In some embodiments, the surface of the at least one beam director includes at least one of a non-reflective surface and a diffusive surface.

In some embodiments, the imaging device includes at least one component disposed in a path of the beam after the beam is redirected by the at least one beam director and configured to alter the path of the beam, where the component includes at least one of a mirror and a lens, and where the component is configured to be articulated relative to the beam director.

In some embodiments, the imaging device includes at least one component disposed in a path of the beam after the beam source and before the projection surface, where the component includes at least one of a mirror and a lens, and where the component is configured to be articulated relative to the beam director. The imaging device may include at least one component disposed in a path of the at least one of beam, beam profile, and redirected beam, where the component includes at least one of a mirror and a lens which modifies the at least one of direction, size, keystone and orientation of the beam, beam profile or redirected beam.

In some embodiments, the beam profile and beam director are configured to move relative to each other. This can be through an articulated reflector, refractor, or diffractor disposed in a position between the beam source and projection surface. As the beam profile is incident on different parts of the beam director, the image on the projection surface changes.

In some embodiments, the beam profile and beam director are configured to move relative to each other. This can be through an articulated or multiple beam sources and beam directors. As the beam profiles are incident on different parts of the beam director or different beam directors, the image on the projection surface changes.

The foregoing general description of the illustrative implementations and the following detailed description thereof are merely exemplary aspects of the teachings of this disclosure, and are not restrictive.

### BRIEF DESCRIPTION OF THE DRAWINGS

The accompanying drawings, which are incorporated in and constitute a part of the specification, illustrate one or more embodiments and, together with the description, explain these embodiments. The accompanying drawings have not necessarily been drawn to scale. Any values dimensions illustrated in the accompanying graphs and figures are for illustration purposes only and may or may not represent actual or preferred values or dimensions. Where applicable, some or all features may not be illustrated to assist in the description of underlying features. In the drawings:

FIG. 1A schematically illustrates a first example imaging system.

FIG. 1B schematically illustrates a second example exemplary imaging system.

FIG. 2A schematically illustrates a third example imaging system.

FIG. 2B schematically illustrates a fourth example imaging system.

FIG. 3 schematically illustrates an example refractive beam director according to a first embodiment.

FIG. 4A schematically illustrates an example reflective beam director according to a second embodiment.

FIG. 4B schematically illustrates an example reflective beam director according to a third embodiment.

FIG. 5A schematically illustrates an orthogonal front profile incident on a beam director in an example imaging system.

FIG. 5B schematically illustrates an isometric view of the system in FIG. 5A.

FIG. 5C schematically illustrates an orthogonal front view of an alternate beam profile incident on an alternate beam director in an example imaging system.

FIG. 5D schematically illustrates an isometric view of the system in FIG. 5A.

FIG. 6 is a flowchart illustrating an example method for projecting an image.

FIG. 7A through FIG. 7D schematically illustrate example imaging systems capable of adjusting image output based on an input beam wavelength;

FIG. 8A and FIG. 8B illustrate a flow chart of an example method for producing an image using an imaging system having a configurator that adjusts beam properties for controlling features of the image output; and

FIG. 9A through FIG. 9C illustrate a flow chart of another example method for producing an image using an imaging system having a configurator that adjusts beam properties for controlling features of the image output.

### DETAILED DESCRIPTION OF ILLUSTRATIVE EMBODIMENTS

The description set forth below in connection with the appended drawings is intended to be a description of various, illustrative embodiments of the disclosed subject matter. Specific features and functionalities are described in connection with each illustrative embodiment; however, it will be apparent to those skilled in the art that the disclosed embodiments may be practiced without each of those specific features and functionalities.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures, or characteristics may be combined in any suitable manner in one or more embodiments. Further, it is intended that embodiments of the disclosed subject matter cover modifications and variations thereof.

It must be noted that, as used in the specification and the appended claims, the singular forms “a,” “an,” and “the” include plural referents unless the context expressly dictates otherwise. That is, unless expressly specified otherwise, as used herein the words “a,” “an,” “the,” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein merely describe points of reference and do not necessarily limit embodiments of the present disclosure to any particular orientation or configuration. Furthermore, terms such as “first,” “second,” “third,” etc., merely identify one of a number of portions, components, steps, operations, functions, and/or points of reference as disclosed herein, and likewise do not necessarily limit embodiments of the present disclosure to any particular configuration or orientation.

Furthermore, the terms “approximately,” “about,” “proximate,” “minor variation,” and similar terms generally refer to ranges that include the identified value within a margin of 20%, 10% or preferably 5% in certain embodiments, and any values therebetween.

All of the functionalities described in connection with one embodiment are intended to be applicable to the additional embodiments described below except where expressly stated or where the feature or function is incompatible with the additional embodiments. For example, where a given feature or function is expressly described in connection with one embodiment but not expressly mentioned in connection with an alternative embodiment, it should be understood that the inventors intend that that feature or function may be deployed, utilized, or implemented in connection with the alternative embodiment unless the feature or function is incompatible with the alternative embodiment.

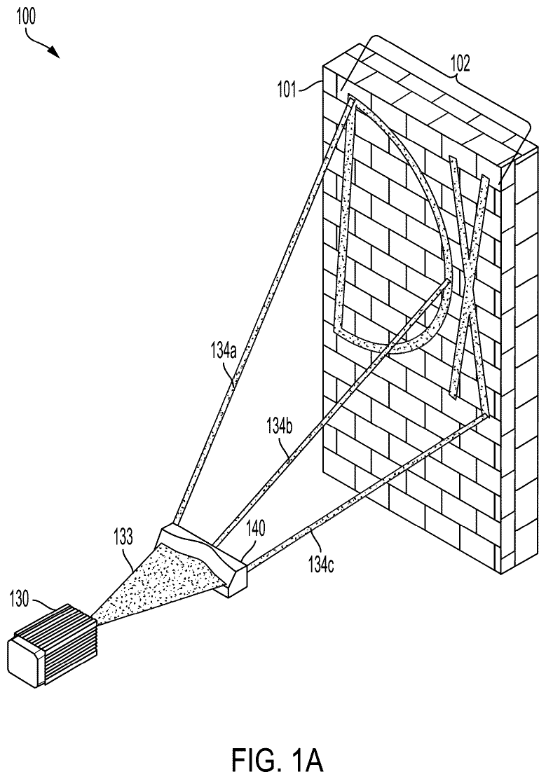

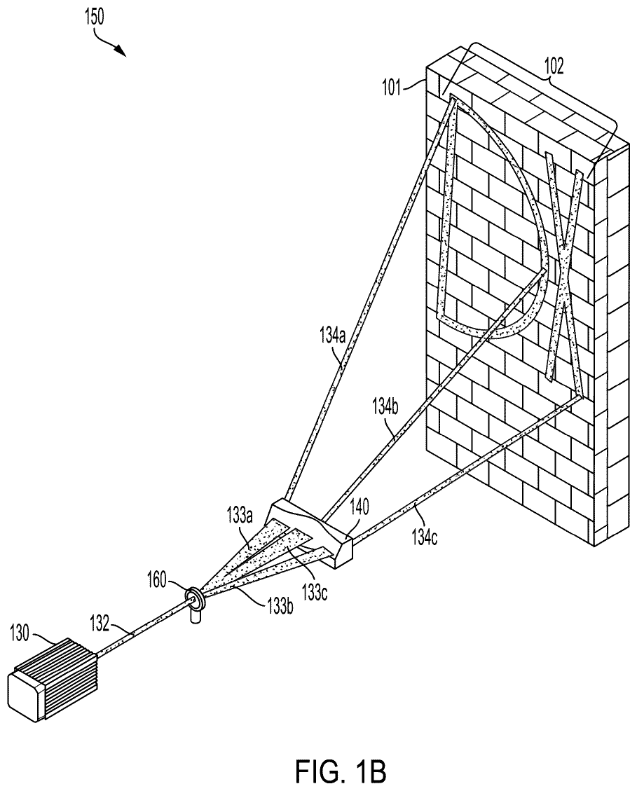

FIG. 1A schematically illustrates an example imaging system 100 designed and configured to display an image 102 (e.g., “DX” as displayed) on a projection surface 101 utilizing a beam director 140. The projection surface 101, in some examples, may be a wall, a floor, a billboard, a hillside, or the forest floor. The beam director 140 alters the path of a beam profile 133, producing an altered beam path 134 (e.g., illustrated as being broken into multiple sub-paths 134a-134c). The beam director 140 may alter the path, in some examples, through reflection, refraction, diffraction or a combination of reflection, refraction, diffraction, scattering, and absorption, depending on the type of beam director 140 utilized. The beam director 140 may alter the path to produce a single altered path or any number of alternate sub-paths 134. Further, the initial beam profile 133, in some embodiments, may include two or more sub-paths. The imaging system 100 includes a beam source 130, such as a laser beam, configured to produce the beam profile 133. To create a stationary image, for example, the beam source 130 and beam director 140 may be maintained in a stationary position. To instead create a mobile or moving image, the beam source 130 and beam director 140 may be repositionable. For example, at least a portion of the imaging system 100 may be supported on a moving platen such that an image may be directed toward multiple angular positions (e.g., projection surfaces, etc.). In another example, the imaging system 100 may be carried by or built into a moving platform, such as a drone, robot, or vehicle.

Similarly, FIG. 1B schematically illustrates an imaging system 150 configured to utilize a beam profiler 160. The imaging system 150 includes a beam source 130 that generates a beam 132, such as a laser beam. To create a stationary image the beam source 130 is maintained in a stationary position, and the beam 132 is emitted along a constant beam path incident on beam profiler 160. The beam profiler 160 modifies the beam into a beam profile 133 using any combination of diffraction, refraction, reflection, scattering and absorption, that is redirected by the beam director 140 on to projection surface 101. As illustrated, the beam profile 133 includes three sub-profiles 133a-c. In other embodiments, any number of sub-profiles may be created by the beam profiler 160.

As the beam profile 133 is redirected by the beam director 140, the altered beam path 134 is created, which when incident upon the projection surface 101 creates at least one image 102.

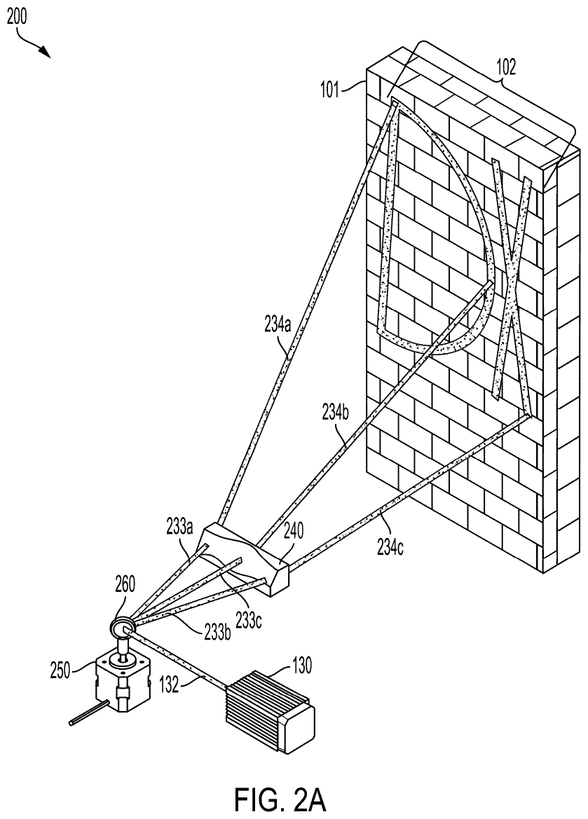

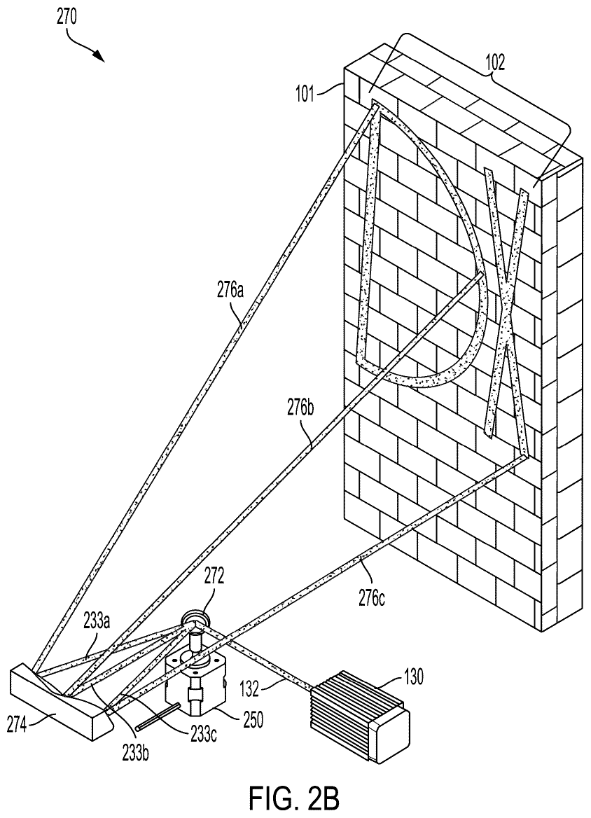

FIG. 2A schematically illustrates the imaging system 200 configured to utilize a refractive articulating beam profiler 260 and refractive beam director 240. The beam 132 is incident on the beam profiler 260. An actuation device 250 (referred to as an actuator), such as a linear or rotary actuator, actuates the beam profiler 260, causing the beam profiler 260 to move relative to the beam 132. By way of non-exclusive example, the relative movement can be a rotation of the beam profiler 260 about an axis, a linear movement of the beam profiler 260, or a combination of the two. The movement of the beam profiler 260 determines the angle that a beam profile 233 is altered by controlling the position or positions that the beam profile 233 is incident on the beam director 240, as illustrated via multiple altered beam paths 234a-c.

Similarly, FIG. 2B schematically illustrates an example imaging system 270 configured to utilize a reflective articulating beam profiler 272 and reflective beam director 274. As an altered beam path 276 moves, the point at which the beam contacts the projection surface 101, and thus the point at which the beam is visible, moves along the projection surface 101. By actuating the beam profiler 272 in cycles, a cohesive image, or multiple distinct images, can be drawn (via tracing) on the projection surface 101. While described herein in singular form, it should be understood that the projection surface 101 can be a single surface, multiple adjacent surfaces, multiple discontinuous surfaces, or any other surface configuration. Further, by cycling the beam profiler 272 faster than the visual recognition rate of a human being, a single shape, or image, is projected onto the projection surface 101. In such an example, the image 102 is traced by the incident light of the altered beam path 276 on the projection surface 101 and the beam profiler 272 is cycled at least 24 cycles per second. In alternative examples, such as those where it is desirable for a person to see the image 102 being traced on a surface, the beam profiler 272 is cycled with fewer cycles per second.

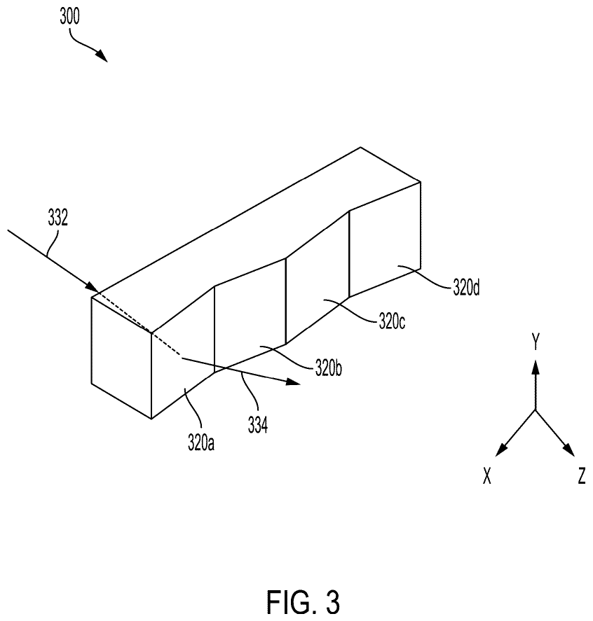

To control the redirection angle of the altered beam path 276, the beam director 274, in some embodiments, includes angled reflection or refraction surfaces (see FIGS. 3-5D), with the angle of the surface at the point of incidence between the beam profile 233 and the reflection or refraction surface of the beam director 274 at least partially determining the angle that the altered beam path 276 is redirected. By way of example, the angle at the point of incidence is determinative of the redirection of the altered beam path 134 in a reflective beam director such as the beam director 274, whereas the angle at the point of incidence in combination with the material selection, as well as a spacing between surfaces is determinative of the redirection of the altered beam path 276 with a refractive beam director.

In the system 270, the position and/or orientation of the beam profiler 272 is altered by the actuator 250, such as a linear actuator or rotary actuator. Alternatively, any similar means of achieving the position and/or orientation change can be utilized to the same effect. Correspondingly, the angle of the reflecting surface or refracting surfaces of the beam director 274, at the position where the beam 132 is incident on the beam director 274, changes along the reflection surface or refraction surfaces, resulting in the position of the altered beam path 276 incident upon the projection surface 101 tracing out an image encoded on the beam director 274 as the beam profiler 272 is actuated.

By utilizing one or more surfaces having multiple set angles at the point of incidence, the resultant image traced out on the projection surface is hard encoded into the beam director. In other words, the physical dimensions of the beam director encode the image that is projected. In some examples, imaging systems such as the example imaging systems 100, 200, and 270 can be designed with the ability to switch out the beam director for an alternate beam director, thereby allowing a user to change the projected image. In yet further examples, multiple beam directors can be included, and a secondary actuation system can be utilized to switch which beam director, or beam profiler, the beam profile, or beam is incident upon during any given operation. In yet further examples, multiple lasers, or other beam sources, and/or a redirection component can be utilized to alter an incident position on the beam director or beam profiler, thereby altering the encoded image that is displayed.

Further, by hard encoding the image on the beam director, relatively simple rotary or linear actuation, or any similar mechanical movement, can be utilized to generate the image, allowing the imaging system to operate without requiring complex controls. By way of example, if the imaging system is designed to project an arrow, or other directional icon, leading individuals to an exit during a fire or similar emergency, a simple rotary or linear actuation system, or a non-moving system can continue to function while a more complex electronic system requiring timed beam sources, multiple synchronized actuated mirrors, or switching between multiple beams and beam directors, would degrade, require maintenance, unintentionally project beams in areas that may be hazardous, or otherwise cease to operate due to the harsh environment.

An example beam director 300 is illustrated in FIG. 3. The beam director 300 may be a clear structure, such as a prism, including one or more refractive surfaces 320. While illustrated as discrete refractive surfaces 320a-d arranged in a linear fashion, one of skill in the art having the benefit of this disclosure will understand that the refractive surfaces 320 can continuously shift from one angle to another angle, without being discrete surfaces via the utilization of a curved surface, or any similar feature. The angle of the refractive surface 320, relative to the beam profile 332, alters the beam path, creating an altered beam path 334 in the X-Y-Z coordinates, referred to moving forward as “three-dimensional space”, causing the point of incidence of the altered beam path on the projection surface to shift. Further, while illustrated in the example beam director 300 as only including refractive surfaces 320a-d on one side of the beam director 300, it should be appreciated that the opposite side of the beam director 300 can also include refractive surfaces. In such an example it is the relative angle between the refractive surfaces that is determinative of the angle by which the altered beam path 334 is redirected.

With reference to FIGS. 1A and 1B, the entire beam profile 133 may be projected concurrently. The beam director 140 likewise may redirect the entirety of the beam profile concurrently into the entirety of the altered beam path 134. The altered beam path 134, for example, shifts in the three-dimensional space corresponding to the angle of the refractive surface of the beam path 134 (e.g., surfaces 320a-d of FIG. 3) or the relative angles of the refractive surfaces 320a-d. The utilization of multiple angled refractive surfaces 320, or a single refractive surface 320 where the instantaneous angle of the surface at the point of incidence of the beam profile 133 changes along the length, causes a shape to be projected on the projection surface 101.

In reference to FIGS. 2A and 2B, the beam profiler 260 is actuated by actuator 250, creating the beam profile 233. As the beam profile 233 is incident the beam director 240, the altered beam path 234 shifts in the three-dimensional space corresponding to the angle of the refractive surface of the beam director 240 (e.g., surface(s) 320 of FIG. 3), or the relative angles of the refractive surfaces 320. The utilization of multiple angled refractive surfaces 320, or a single refractive surface 320 where the instantaneous angle of the surface at the point of incidence of the beam profile 233 changes along the length, causes a shape to be traced out on the projection surface 101.

In one such an example, the actuator 250 is a linear actuator that causes the beam profiler 260 to move back and forth along the line of actuation. By cycling the beam profiler 260 in full cycles at greater than 24 cycles per second, the shape is traced on the projection surface 101 faster than the refresh rate of the human eye, causing a viewer to see a single drawn shape.

In alternative examples, the actuator 250 may move in a rotary motion, a combination of linear and rotary or other motions.

Further, as with the reflective example of FIG. 2B, the actuation of the beam profiler 272 by the actuator 250 allows the imaging system to be safely functional in harsh environments, or with minimal controls, thereby facilitating its use in emergency warning/notification systems, low maintenance systems, and the like.

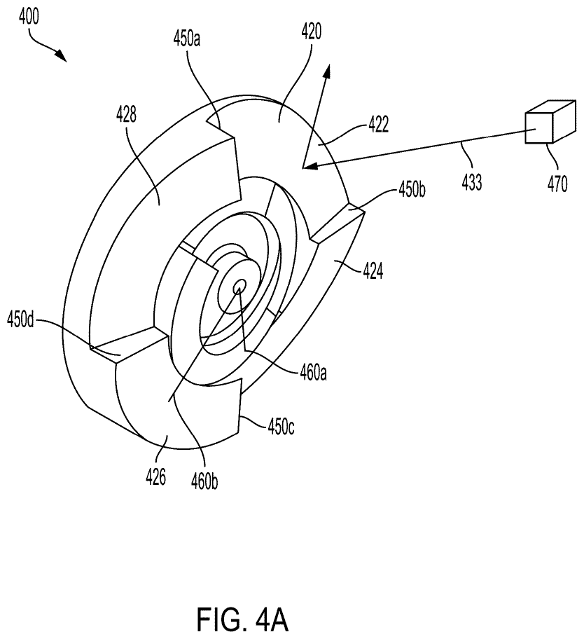

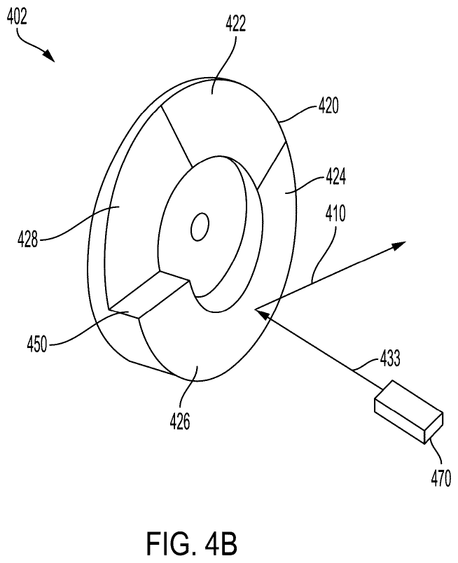

FIG. 4A and FIG. 4B schematically illustrate alternative example beam directors 400 and 402, respectively. In each example, the beam director 400, 402 includes a reflecting composite surface 420 having multiple angled facing surface 422, 424, 426, 428. Each of the angled facing surfaces 422, 424, 426, 428 in the example of the beam director 400 of FIG. 4A is connected to an adjacent angled facing surface 422, 424, 426, 428 by a discontinuous surface 450a-d. In contrast, each of the angled facing surfaces 422, 424, 426, 428 in the example beam director 402 of FIG. 4B is connected to at least one adjacent angled surface 422, 424, 426, 428, and only a single discontinuous surface 450 is utilized. The angle of the reflecting composite surface 420 at the point struck by the beam profile 433 changes at the points of incidence on the beam director 400. This change causes the altered beam path to change its path in three-dimensional space. Each of the angled facing surfaces 422, 424, 426, 428 includes one or more angles, relative to the beam profile 433, with the angle of the reflecting composite surface 420 at any given radial position determining the angle in three-dimensional space by which the beam profile 433 is altered.

As the angle of the facing surfaces 422, 424, 426, 428 along the incident arc are not constant across the arc length of the facing surface 422, 424, 426, 428 the angle that the beam profile 433 is reflected is changed at the different points of incidence on each beam director 400, 402. This altered reflection angle in turn allows an image to be projected as described above.

Each of the discontinuous surfaces 450 can be non-reflective, diffusive, or can reflect away from the projection surface. In this manner, multiple distinct images, or breaks within a single image, can be encoded on a single beam director. Alternatively, the facing surfaces 422, 424, 426, 428 can form a more complex single image including two or more disjointed image elements. In yet further alternatives, the facing surfaces 422, 424, 426, 428 can be utilized to create a single continuous image.

In some example embodiments, such as the example of FIG. 4A, the specific images are encoded at a given radius 460a, b on the beam director. In such an example, additional images can be encoded at different radii 460′. During operation an actuator can shift a beam profiler 470 such that the arc along which the beam profile 433 is incident on the beam director 400, 402 is shifted, allowing the beam director 400, 402 to shift between the encoded images as necessary. In alternative examples, mirrors, reflective surfaces, lenses, a change in actuator profile, actuation of the beam director or similar could be utilized to achieve the shifting between encoded images by altering the incident position of the beam profile 433.

In yet further examples, multiple beam directors can be included within the imaging device. In such examples, a controller can transition the imaging device between the beam directors, and multiple images can be stored in the imaging device.

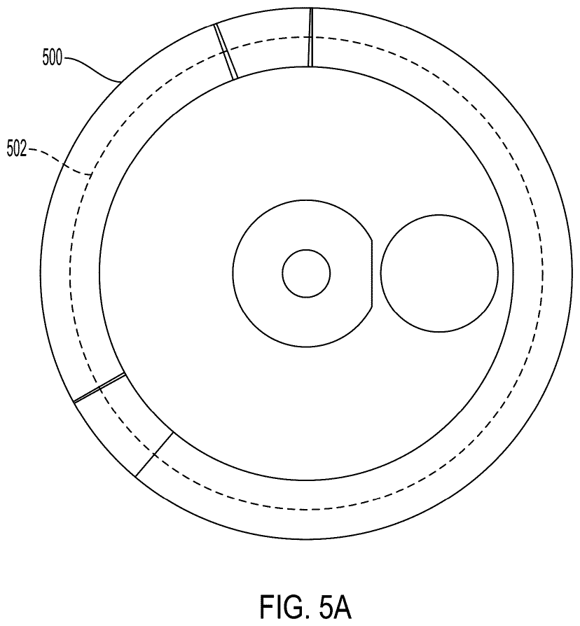

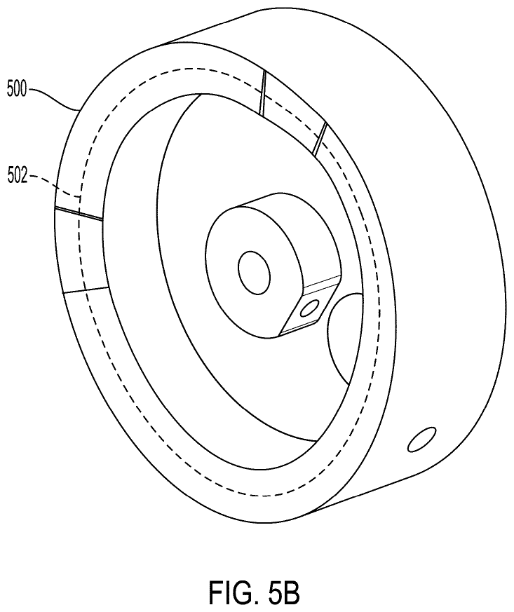

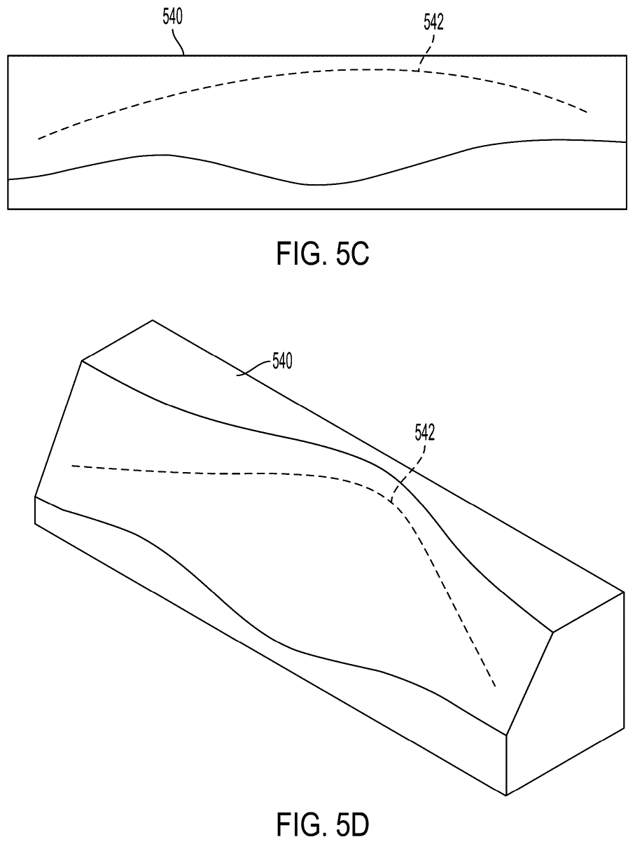

FIG. 5A shows an orthogonal front view of a first example beam director 500 with an example incident beam profile 502. FIG. 5B shows an isometric view of the beam director 500. FIG. 5C shows an orthogonal front view of a second example beam director 540 with an example incident beam profile 542. FIG. 5D is an isometric view of the beam director 540. With reference to FIGS. 5A-5D, the beam profile 502, 542 does not contain images or information, that is on the beam director 500, 540. In alternative examples, there can be locations on the beam director 500, 540 to be incident with one or more beam profiles 502, 542 for multiple images or information. In yet further examples, the beam profile 502, 542 may be swept through more than one location of incidence to transition between different images or information.

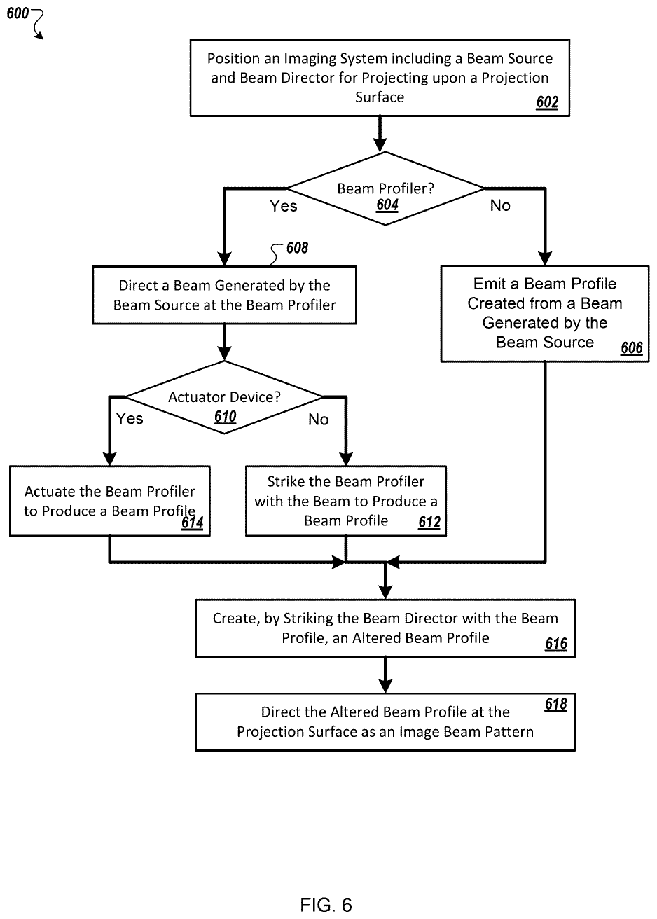

FIG. 6 illustrates a flowchart describing an example method 600 of projecting an image using any of the above-described imaging devices.

In some implementations, the method begins with positioning an imaging system including a beam source and beam director for projecting upon a projection surface (602). The imaging system, in some examples, may be, or include components from, the imaging system 100 of FIG. 1A, the imaging system 150 of FIG. 1B, the imaging system 200 of FIG. 2A, and/or the imaging system 270 of FIG. 2B.

In some implementations, if the imaging system does not include a beam profiler (604), a beam profile created from a beam generated by the beam source is emitted (606). The beam generated by the beam source may be considered as an initial beam profile. In another example, the beam profile may be redirected from a beam produced by a beam source, such as by mirrors.

In some implementations, if the imaging system includes a beam profiler (604), a beam generated by the beam source is directed at the beam profiler (608). The beam directed at the beam profiler may be considered as an initial beam profile. For example, as illustrated in the system 150 of FIG. 1B, the beam 132 (e.g., initial beam profile) is generated by the beam source 130 and directed at the beam profiler 160. Similarly, the beam 132 may be directed at the beam profiler 260, as illustrated in the imaging system 200 of FIG. 2A, or the beam 132 may be directed at the beam profiler 272 of the imaging system 270, as illustrated in FIG. 2B.

In some implementations, if the imaging system does not include an actuator device for the beam profiler (610), the beam strikes the beam profiler to produce a beam profile (612). The beam profiler, as explained above, may create a beam profile by directing a light beam through shaped openings, mirrors, lenses, diffraction gratings, and/or other optical elements that modify, split, and/or otherwise redirect the light beam. As illustrated in FIG. 1B, for example, the beam profiler 160 splits the initial beam 132 to produce a beam profile 133 having a set of sub-beams 133a-c.

In some implementations, if the imaging system does have an actuator device (610), the beam profiler is actuated to produce the beam profile (614). As described in relation to the actuator 250 of FIG. 2A and FIG. 2B, for example, the actuator may be a rotary or linear actuator that articulates, causing the beam to trace and/or shift a beam profile.

In some implementations, whether the beam profile is an initial beam profile created from the beam generated by the beam source or the initial beam profile has been adjusted through directing the initial beam profile at a stationary or articulating beam profiler, an altered beam profile is created by striking the beam director with the beam profile (616). The beam profile may be incident on the beam director. The beam director, in some examples, may be the beam director 300 of FIG. 3, the beam director 400 of FIG. 4A, the beam director 402 of FIG. 4B, or the beam director 500 of FIG. 5A and FIG. 5B. As illustrated in FIG. 1A, for example, the initial beam profile 133 strikes the beam director 140. As illustrated in FIG. 1B, the beam profile 133 produced by the beam profiler 160 strikes the beam director 140. Similarly, as illustrated in FIG. 2A, the beam profile 133 produced by the beam profiler 260 strikes the beam director 240. In another example, as illustrated in FIG. 2B, the beam profile 133 produced by the beam profiler 272 strikes the beam director 274.

In some implementations, the altered beam profile produced by the beam director is directed at the projection surface as an image beam pattern (618). As described above, the altered beam profile may produce one or more stationary or moving images. The images, for example, may be produced in part through relative movement between the beam profiler and the beam director, relative movement between the beam profile (e.g., by moving the beam source or an intervening component) and the beam director, and/or relative movement between the image beam pattern and the projection surface (e.g., by moving an intervening component between the beam director and the projection surface). The relative movement, for example, may cyclically trace the one or more images.

In some embodiments, a beam director is geometrically encoded with two or more images, such that relative movement between the beam profile and the beam director switches between images encoded on the beam director. In an illustrative example, a single beam director may be geometrically encoded with two separate images, each encoded in a different region of the beam director. The beam profile may be directed at a first region of the beam director to cause presentation of a first image, and then, via relative movement between the beam profile and the beam director, directed at a second region to cause presentation of a second image. The redirecting may be gradual or abrupt. The beam may be controlled to cycle off between images to separate perception of presentation between the two images. To create the perception, during presentation, of the first image morphing into the second image and vice-versa, the redirection may be gradual while the beam is substantially on (e.g., on or cycling at a rate that allows perception of morphing when viewed by the human eye). The geographic regions may be disposed relative to each other in any orientation (e.g., side-by-side, above and below, contiguous or non-contiguous, etc.).

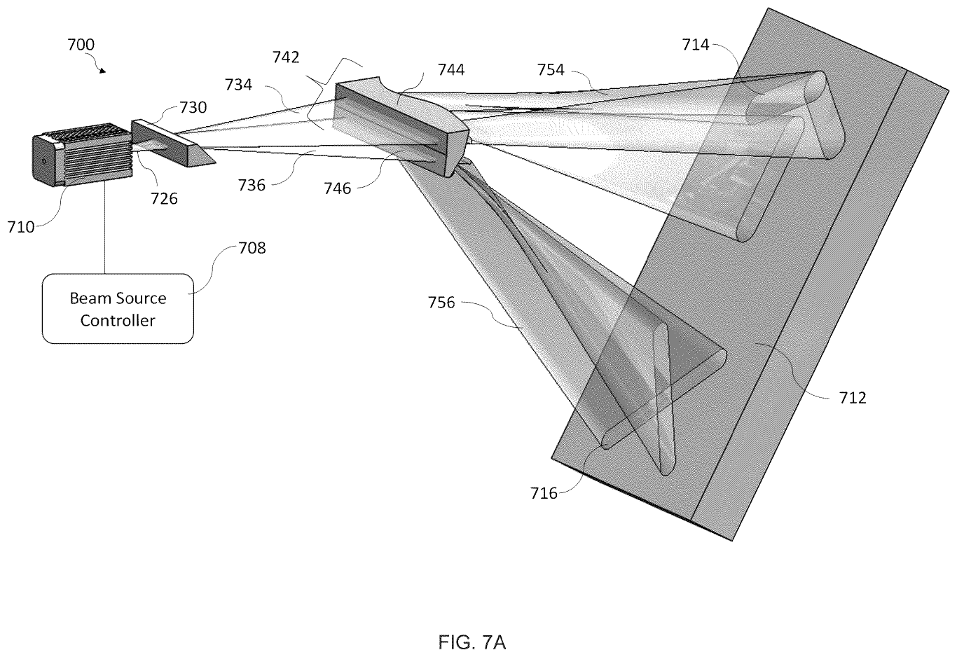

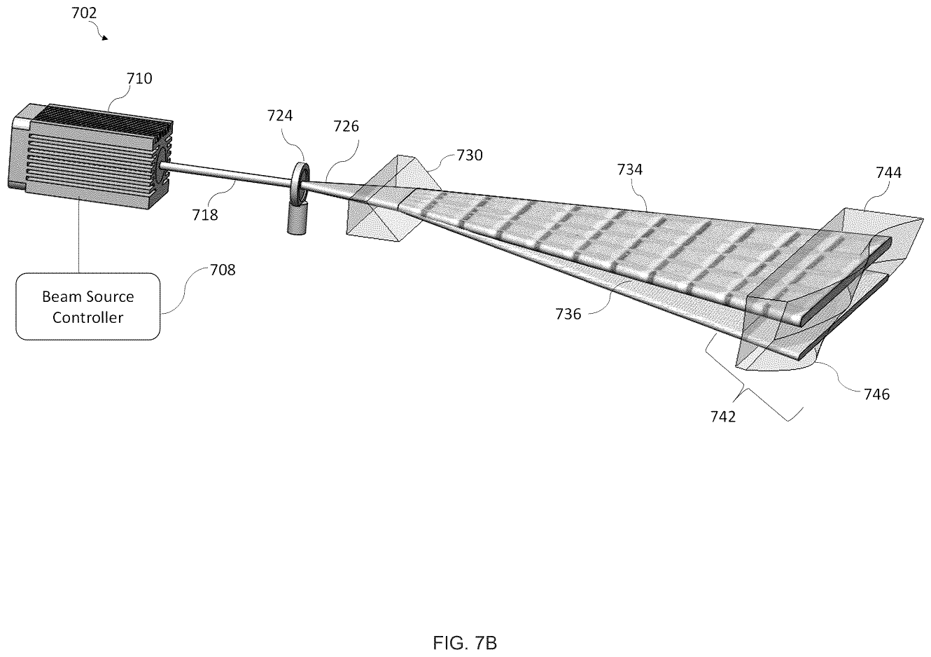

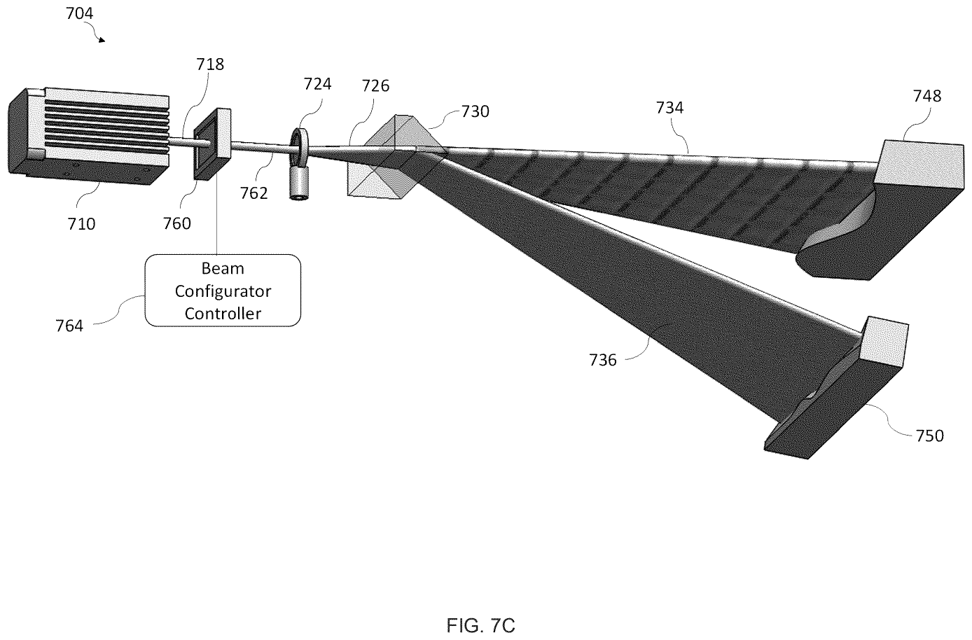

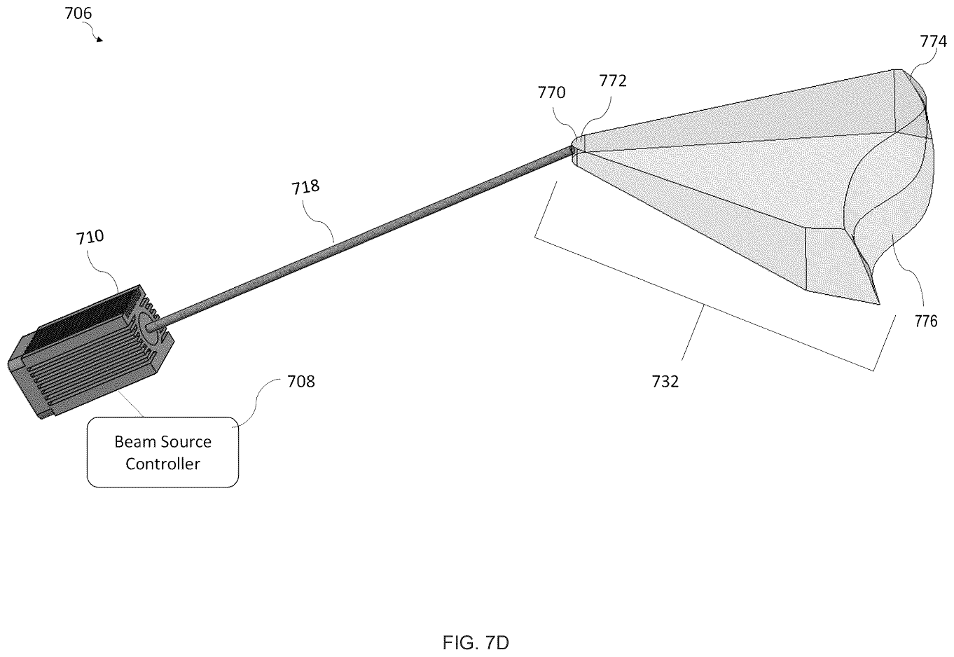

FIG. 7A through FIG. 7C illustrate example imaging systems capable of adjusting the image output responsive to modified properties or characteristics of a beam or beam profile (e.g., produced by a beam source). The beam or beam profile may be modified at or after the beam source. The properties or characteristics of a particular beam (single beam or at least a portion of a beam profile), in some examples, may include a color, wavelength, and/or polarization of the particular beam. Although, for ease of example and clarity of illustration of individual elements, the example imaging systems of FIG. 7A through FIG. 7C are fairly streamlined in their designs, in other embodiments, imaging systems incorporating components for modifying a beam or beam profile may include additional aspects of the imaging systems described in relation to previously discussed examples, such as, for instance, the actuation device 250 of FIG. 2A or the articulating beam profiler 272 of FIG. 2B. Additionally, although the imaging systems illustrated in FIG. 7A through FIG. 7C are configured to produce two example images, in other embodiments, the imaging systems may be configured to produce any number of discrete images.

FIG. 7A schematically illustrates an example imaging system 700 (e.g., similar to imaging system 100 of FIG. 1A) designed and configured to display a first image 714 (e.g., an upward pointing arrow as displayed) and a second image 716 (e.g., “X” as displayed) on a projection surface 712 (similar to projection surface 101 of FIG. 1A) utilizing a multiple beam director 742. Although illustrated as a particular style and shape of beam director, in other embodiments, the multiple beam director 742 may incorporate design aspects described above, such as aspects discussed in relation to FIG. 3, FIG. 4A, or FIG. 4B. The images 714 and 716, for example, may be rendered on the projection surface 712 in a similar manner to the image 102 of FIG. 1A. The projection surface 712, in some examples, may be a wall, a floor, a billboard, a hillside, or a forest floor. The imaging system 700 includes a beam source 710 (similar to beam source 130 of FIG. 1A), such as a laser beam, configured to produce a beam profile 726 (similar to beam profile 133 of FIG. 1A).

In some implementations, the beam profile 726 is incident on, or enters, or is modified, by a beam diverter 730. The beam diverter 730 may be any element that can be used to direct the beam profile using any combination of diffraction, refraction, reflection, scattering, and/or absorption. By way of non-exclusive example, the beam diverter 730 could be a type of beamsplitter, diffraction grating, diffraction optical element, or other optical element. In the illustrative example, the beam diverter 730 is represented as a prism which affects a beam of light differently based on the wavelength of the beam of light. In another example, the beam diverter 730 may affect the beam of light differently based on the polarization of the beam of light. The beam diverter 730, for example, may be a stationary element diverting or redirecting the beam profile 726 according to characteristics of the beam of light (e.g., wavelength, polarization), such that beams of different characteristics (e.g., different colors of light, such as red versus blue) will be directed through a different path of the beam diverter 730. A beam source controller 708 may be used, for example, to control the beam source 710 to manipulate the properties of the beam profile 726, (e.g., by way of non-exclusive example, the polarization or wavelength) in a manner related to the beam diverter 730. The beam source controller 708, for example, may be built into the beam source or in wired or wireless communication with the beam source. The beam source controller 708, in some embodiments, is configured to automatically manipulate the properties of the beam profile 726 in at least one programmed pattern. In other embodiments, the beam source controller 708 is configured to be selectively programmed. For example, the beam source controller 708 may include one or more input elements, such as a button, a switch, a wireless communication interface, and/or a wired interface (e.g., with a CPU or other controller processing circuitry) for instructing manipulation of the properties of the beam profile 726. The beam source controller 708, for example, may be pre-programmed to produce one or more outputs and/or output patterns based on one or more settings provided via the one or more input elements. In further embodiments, the beam source controller 708 may receive sensor feedback from one or more sensors, such as a light sensor, an orientation sensor, and/or a color sensor, to selectively adjust images generated by the imaging system 700. In some embodiments, the beam source 710 may be mechanically actuated or manipulated. In an illustrative example, a color and/or brightness of the resultant image may be selectively altered via the beam source controller 708 based on a light sensor (e.g., determining whether daytime or nighttime light is available in the vicinity of the imaging system 700). The beam diverter 730 potentially creates none, one, or both diverted beam profile 734 and diverted beam path 736 depending on the properties of beam profile 726. In some embodiments, the beam diverter 730 is configured to produce at least a first image based on the beam profile 726 retaining original properties produced by the beam source 710 (e.g., unmodified by the beam source controller 708).

In some embodiments, the multiple beam director 742 is a beam director unit including two beam directors 744 and 746 (e.g., both similar to beam director 140 of FIG. 1A). In other embodiments, a multiple beam director may include three or more beam directors. However, for simplicity's sake, only two are addressed in the figure. If the diverted beam profile 734 is created, the beam director 744 alters the path of a diverted beam profile 734, producing altered beam path 754 (e.g., similar to altered beam path 134a-134c of FIG. 1A), which creates the image 714 when it strikes the projection surface 712. If the diverted beam path 736 is created, the beam director 746 alters the path of diverted beam path 736, producing an altered beam path 756 (e.g., similar to altered beam path 134a-134c of FIG. 1A), which creates the image 716 when it strikes projection surface the 712.

Similarly, FIG. 7B schematically illustrates an example imaging system 702 (e.g., similar to imaging system 150 of FIG. 1B) configured to use a beam profiler 724 (e.g., similar to beam profiler 160 of FIG. 1B). For clarity, the projection surface 712, image 714, image 716, altered beam path 754, and altered beam path 756, as illustrated in FIG. 7A, have been omitted. The imaging system 702 includes the beam source 710 that generates the beam 718 (e.g., similar to beam 132 of FIG. 1B), such as a laser beam. The beam 718 may be emitted along a constant beam path incident on the beam profiler 724. The beam profiler 724, for example, may modify the beam 718 into the beam profile 726 using any combination of diffraction, refraction, reflection, scattering, and/or absorption. The beam profile 726 is incident on, or enters, or is modified, by the beam diverter 730, as described, for example, in relation to FIG. 7A. Similar to the imaging system 700 of FIG. 7A, in some embodiments, the beam profiler 724 is configured to produce at least a first image based on the beam 718 retaining original properties produced by the beam source 710 (e.g., unmodified by the beam source controller 708).

Similarly, FIG. 7C schematically illustrates an example imaging system 704 configured to use a beam configurator 760. For clarity, the projection surface 712, the image 714, the image 716, the altered beam path 754, and the altered beam path 756, as illustrated in FIG. 7A, have been omitted. The imaging system 704 includes the beam source 710 that generates the beam 718 emitted along a constant beam path which is incident on, or enters, or is modified, by the beam configurator 760. The beam configurator 760 is configured to manipulate the properties of the beam 718 in a manner related to the beam diverter 730 to create a configured beam 762. By way of non-exclusive example, the beam configurator may manipulate the polarization and/or wavelength of the beam 718. Similar to the imaging systems 700 of FIGS. 7A and 702 of FIG. 7B, in some embodiments, the imaging system 704 is configured to produce at least a first image based on the beam 762 retaining original properties of beam 718 produced by the beam source 710 (e.g., unmodified by the beam configurator controller 764). The beam configurator 760, for example, may be adapted to cycle through beam property options (e.g., via a mechanical actuator, electrical adjustment, etc.) automatically or semi-automatically (e.g., based on a switch or other mechanical selector setting a mode of the beam configurator 760).

In some implementations, a beam configurator controller 764 is used to control what and how the properties of the beam 718 are modified (or not modified) by the beam configurator 760. The beam configurator controller 764, for example, may be programmed, set, actuated, or controlled in a similar manner as described in relationship to the beam source controller 708 of FIG. 7A and FIG. 7B. The configured beam 762 is emitted such that it is incident on beam profiler 724. The beam profiler 724 modifies the beam into a beam profile 726 using any combination of diffraction, refraction, reflection, scattering, and absorption. This example shows the beam configurator 760 and beam profiler 724 in a specific order, however, these elements could be arranged in a different order in other embodiments. The beam profile 726 is incident on, or enters, or is modified, by the beam diverter 730. The beam diverter 730 potentially creates none, one, or both diverted beam profile 734 and diverted beam path 736 depending on the properties of beam profile 726. If the diverted beam profile 734 is created, the beam director 748 alters the path of the diverted beam profile 734, producing one or more altered beam paths (e.g., beam path 754) and one or more images (e.g., image 714), similar to FIG. 7A. If the diverted beam path 736 is created, beam director 750 alters the path of diverted beam path 736, producing one or more altered beam paths (e.g., beam path 756) and one or more images (e.g., image 716), similar to FIG. 7A.

Turning to FIG. 7D, an example imaging system 706 is configured to use a combination beam diverter profiler multiple director 732 which embodies, in a single physical element, multiple elements discussed in relation to FIG. 7A through FIG. 7C. The combination beam diverter profiler multiple director 732 combines functional aspects of a beam diverter (e.g., beam diverter 730 of FIG. 7A), a beam profiler (e.g., beam profiler 724 of FIG. 7B), and a multiple beam director (e.g., multiple beam director 742 of FIG. 7B) into a single unit (e.g., combined within a single housing or produced as a single contiguous apparatus). For clarity, the projection surface 712, image 714, image 716, altered beam path 754, altered beam path 756, diverted beam profile 734, diverted beam path 736, beam profiler 724, and beam profile 726, described above in relation to FIG. 7A through FIG. 7C, have been omitted. The imaging system 706 includes the beam source 710 that generates the beam 718, as described in relation to FIG. 7B. The beam 718 is emitted along a constant beam path incident on the combination beam diverter profiler multiple director 732.

In some implementations, upon entering the combination beam diverter profiler multiple director 732, the beam 718 will pass through and be transformed into a beam profile by a beam profiler element 770 in a manner similar to that described in relation to the beam profiler 724 of FIG. 7A. Next, the beam profile will encounter a beam diverter element 772 configured to function similarly to the beam diverter 730 of FIG. 7A, resulting in a diverted beam profile. From the beam diverter element 772, depending upon a path of the diverted beam profile caused by the beam diverter element 772, the diverted beam profile may encounter a first beam director element 774, similar to the beam director 744 of FIG. 7B, and/or a second beam director element 776, similar to the beam director 746 of FIG. 7B.

Although described in relation to a particular set of elements arranged in a particular order, in other embodiments, various individual elements described in relation to prior imaging systems may be combined into a single housing or unit. Individual elements within a combination unit, further, may be configured to perform the functions of multiple elements of other imaging systems described herein. In illustration, the orientation of a cylinder lens (e.g., disposed approximately where the beam profiler element and the beam diverter element 772 are indicated in FIG. 7D) may be configured to behave as both a beam profiler and a beam diverter. The resultant diverted beam paths may then be redirected by a beam director end of the example multiple unit (e.g., a region including references to the first beam director element 774 and the second beam director 776 are located). Further, in various embodiments, the combined units may be formed of one or multiple materials. For example, a three-dimensionally printed or CNC (computer numerical control) machined combination element may include various geometries and beam adjustment properties (e.g., reflection, refraction, etc.) designed into a monolith unit.

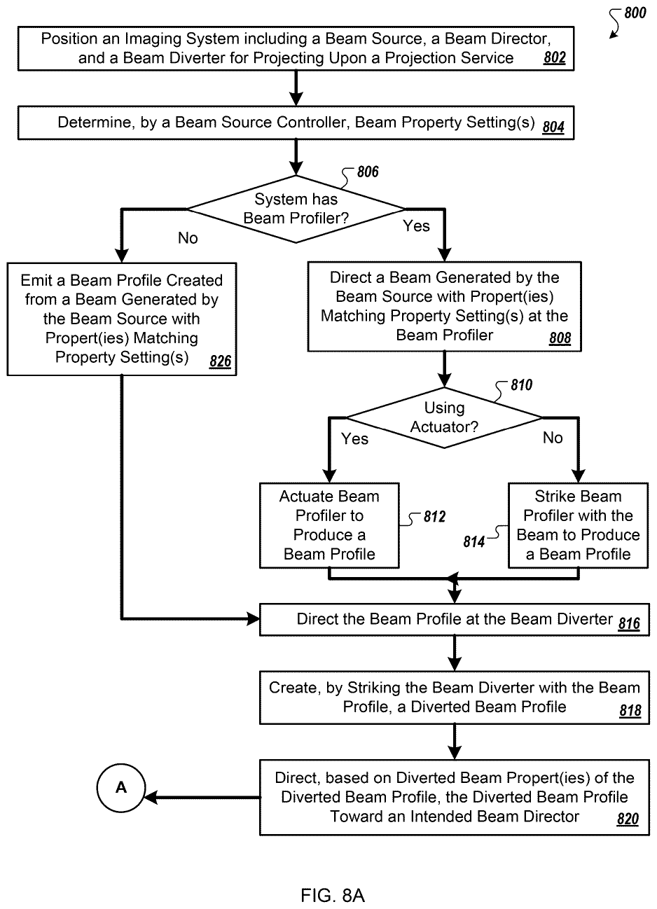

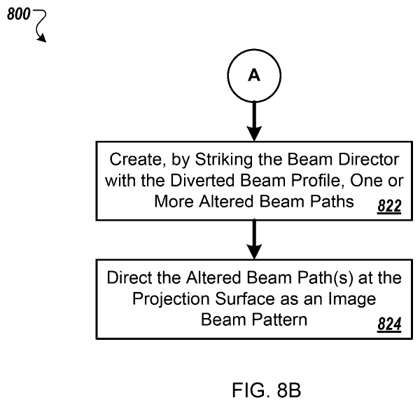

FIG. 8A and FIG. 8B illustrate an example method 800 for producing an image using an imaging system having a beam source controller that adjusts beam properties for controlling features of the image output. The beam source controller, for example, may control one or more presentation features of a particular image, such as controlling selection of color, size, positioning, and/or brightness of a resultant image. In a further example, the beam source controller may select to output a given one or more images of multiple possible images that an imaging system is capable of producing. The imaging system, for example, may include components from the imaging system 700 of FIG. 7A.

In some implementations, the method 800 begins with positioning an imaging system including a beam source, a beam director, and a beam diverter for projecting an image upon a projection surface (802). The imaging system may be positioned, for example, in one of the manners described in relation to operation 602 of FIG. 6. The beam source may be similar to beam source 710 in FIG. 7A. The beam directors may be similar to beam directors 744 and 746 of FIG. 7A, or beam directors 748 and 750 of FIG. 7C. The beam diverter may be similar to beam diverter 730 in FIG. 7A.

In some implementations, one or more beam property settings are determined by a beam source controller (804). The beam source controller, for example, may be the beam source controller 708 from FIG. 7A. The beam property settings could, by way of non-exclusive example, be the wavelength or polarization of the of the output of the beam source. These properties are selected, for example, to create an intended image or images similar to image 714 and 716 of FIG. 7A.

In some implementations, if the beam source is configured to emit a beam profile (806), a beam profile created from a beam generated by the beam source with one or more properties matching the one or more property settings is emitted (826). The beam profile may be similar to beam profile 726 of FIG. 7A. The beam profile may have properties such as, by way of non-exclusive example, wavelength and polarization, determined by the beam source controller similar to beam source controller 708 of FIG. 7A.

In some implementations the beam profile is directed at a beam diverter (816). The diverter may be the diverter 730 of FIG. 7A.

In some implementations, a diverted beam profile is created by striking the beam diverter with the beam profile (818). The beam profile may be directed to the diverter, for example, in a manner similar to that described in relation to the diverter 730 of FIG. 7A. When the beam profile strikes the beam diverter, it may create one, multiple, or zero diverted beam profiles (e.g., similar to diverted beam profile 734 and diverted beam path 736 of FIG. 7A).

In some implementations, the diverted beam profile is directed toward an intended beam director based on the one or more diverted beam properties of the diverted beam profile and according to the beam diverter (820). For example, the diverted beam profiles may be directed toward a beam director, such as described in relation to beam directors 744 and 746 of FIG. 7A, the beam directors 748 and 750 of FIG. 7C, and/or the multiple beam director 742 of FIG. 7A. Further, in some embodiments, the diverted beam profile may be selectively directed toward another element or a projection surface, bypassing any beam director.

Turning to FIG. 8B, in some implementations, the diverted beam profiles strike the beam director or beam directors, creating one or more altered beam paths (822). The altered beam path(s) may be created, for example, in a manner similar to that described in relation to altered beam paths 754 and 756 of FIG. 7A.

In some implementations, the altered beam paths are directed at the projection surface as an image beam pattern (824). The altered beam paths, for example, may be directed to strike one or multiple projection surfaces, similar to the projection surface 712 in FIG. 7A, creating an image or images such as the images 714 and 716 of FIG. 7A.

Returning to FIG. 8A, in some implementations where the imaging system is configured to use a beam profiler (806), a beam generated by the beam source and with one or more properties matching the one or more property settings, is directed at the beam profiler (808). The beam profiler, for example, may be similar to the beam profiler 724 of FIG. 7B. The beam generated by the beams source has properties such as, by way of non-exclusive example, wavelength and polarization, determined by the beam source controller similar to beam source controller 708 of FIG. 7B.

In some implementations, when the imaging system is not using an actuator to produce a beam profile (810), the beam strikes the beam profiler to produce a beam profile (814). The beam profile, for example, may be similar to the beam profile 726 described in FIG. 7B.

Alternatively, in some implementations where the imaging system uses an actuator (810), the beam profiler is actuated to produce a beam profile (812). The beam profiler may be actuated, for example, in a manner similar to that described in relation to beam profiler 260 and actuation device 250 of FIG. 2A.

In some implementations, the beam profile is directed at a beam diverter (816). and creates, by striking the beam diverter with the beam profile, a diverted beam profile (818) as described above. The diverted beam profile is then directed toward an intended beam director (820) as described above. Further, the path continues in 8B by creating the one or more altered beam paths (822) and directing the altered beam path(s) at the projection surface as an image beam pattern (824). Although described in relation to a particular set of operations, in other embodiments, the method 800 may include more or fewer operations. For example, there could be one or more additional lenses, mirrors, or other optical elements to redirect or modify the beam, the beam profile, the diverted beam profile, the altered beam paths, and/or image beam pattern or image. These lenses, mirrors, or other optical elements may or may not be actuated. These elements could serve many purposes, for example such as increasing or decreasing the projector size, increasing or decreasing image size in a given direction, increasing or decreasing image size in multiple dimensions, increasing or decreasing the focus of the image on the projection surface(s), moving the image, moving the image to other projection surface(s), and many other purposes. Further, although described in relation to a particular order of operations, in other embodiments, certain operations of the method 800 may be performed in a different order and/or at least partially concurrently. For example, a beam diverter could be placed before one or multiple beam profilers such that one or multiple beam directors can make one or multiple images. In another example, multiple beam diverters may be used to create multiple diverted beams and or diverted beam profiles. Other modifications of the method 800 are possible.

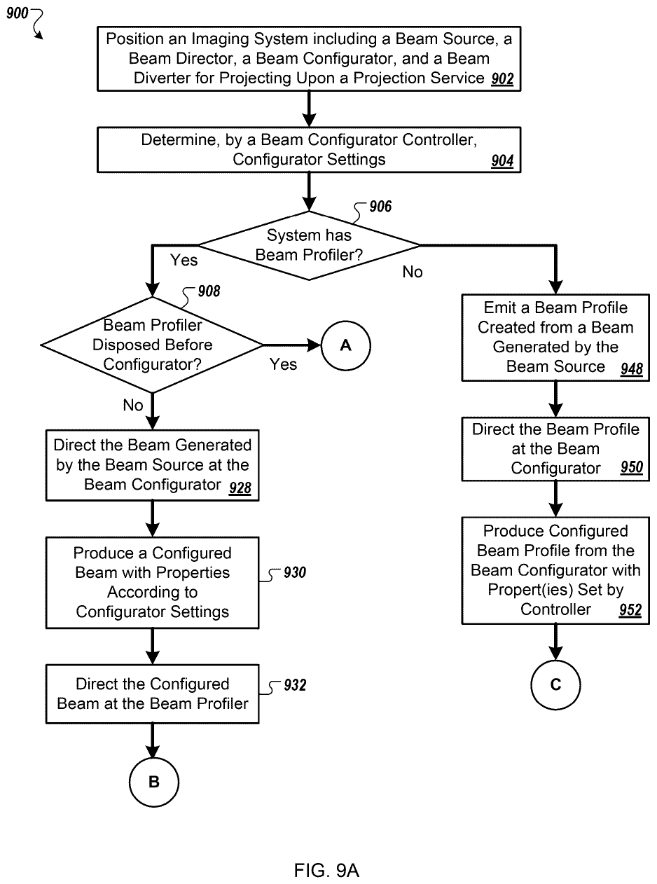

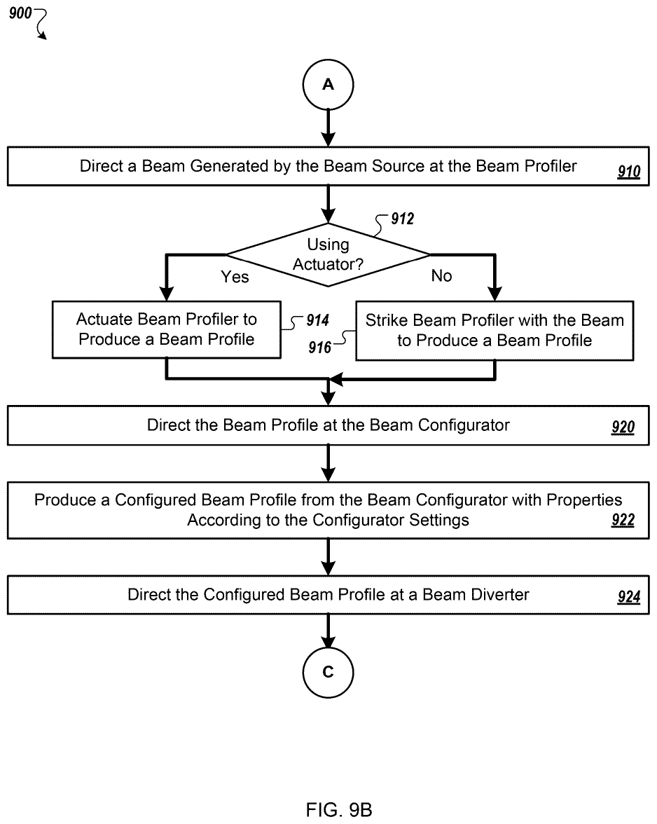

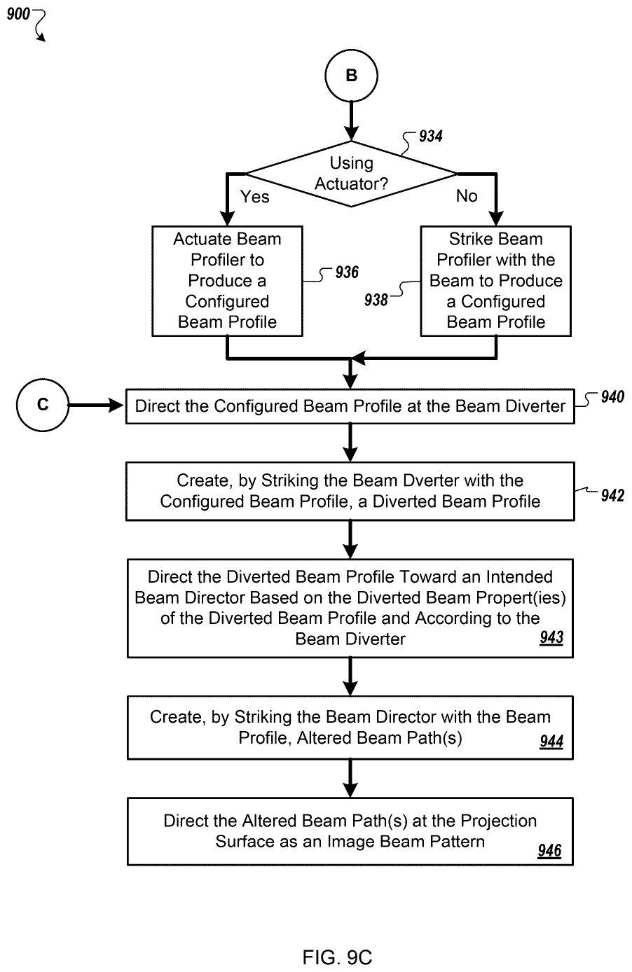

FIG. 9A through FIG. 9C illustrate a flow chart of another example method 900 for producing an image using an imaging system having a beam configurator that adjusts beam properties for controlling features of the image output. The beam configurator, for example, may control one or more presentation features of a particular image, such as controlling selection of color, size, positioning, and/or brightness of a resultant image. The beam configurator may be similar to the beam configurator 760 of FIG. 7C. In a further example, the beam configurator may select to output a given one or more images of multiple possible images that an imaging system is capable of producing. The imaging system, for example, may include components from the imaging system 704 of FIG. 7C.

In some implementations, the method 900 begins with positioning an imaging system including a beam source, a beam director, a beam configurator, and a beam diverter for projecting an image upon a projection surface (902). The imaging system may be positioned, for example, in one of the manners described in relation to operation 602 of FIG. 6. The beam source may be similar to beam source 710 in FIG. 7C. The beam directors may be similar to beam directors 744 and 746 of FIG. 7A, or beam directors 748 and 750 of FIG. 7C. The beam diverter may be similar to beam diverter 730 in FIG. 7C.

In some implementations, one or more beam configurator settings are determined by a controller (904). The controller, for example, may be similar to the beam configurator controller 764 of FIG. 7C. By way of non-exclusive example, the configurator settings may include wavelength or polarization of the configured beam or configured beam profile. The configured beam may be similar to configured beam 762 of FIG. 7C. These properties are selected, for example, to create an intended image or images similar to image 714 and 716 of FIG. 7A.

In some implementations, if the beam source is configured to emit a beam profile (906), a beam profile is emitted from a beam generated by the beam source (948). The beam profile may be similar to beam profile 133 for FIG. 1A. In some implementations, a beam profile is directed at the beam configurator (950).

In some implementations, a configured beam profile is produced with one or more properties matching the one or more property settings determined or set the beam configurator controller (952). The beam profile, for example, may be incident on, enter, or modified by the beam configurator, creating or emitting the configured beam profile. The configured beam profile may have properties such as, by way of non-exclusive example, wavelength and polarization, determined by the beam configurator controller similar to beam configurator controller 764 of FIG. 7C.

Turning to FIG. 9C, in some implementations, the configured beam profile is directed at the beam diverter (940).

In some implementations, a diverted beam profile is created by striking the beam diverter with the configured beam profile (942). The configured beam profile may be directed to the diverter, for example, in a manner similar to that described in relation to the diverter 730 of FIG. 7C. When the configured beam profile strikes the beam diverter, it may create one, multiple, or zero diverted beam profiles (e.g., similar to diverted beam profile 734 and diverted beam path 736 of FIG. 7C). For example, the “diverted beam profile” may, in some circumstances, be identical to the configured beam profile.

In some implementations, the diverted beam profile is directed toward an intended beam director based on the one or more diverted beam properties of the diverted beam profile and according to the beam diverter (943). For example, the diverted beam profile may be directed toward a beam director, such as described in relation to beam directors 744 and 746 of FIG. 7A, the beam directors 748 and 750 of FIG. 7C, and/or the multiple beam director 742 of FIG. 7A. Further, in some embodiments, the diverted beam profile may be selectively directed toward another element or a projection surface, bypassing any beam director.

In some implementations, the diverted beam profiles strike the beam director or beam directors, creating one or more altered beam paths (944). The altered beam path(s) may be created, for example, in a manner similar to that described in relation to altered beam paths 754 and 756 of FIG. 7A.

In some implementations, the altered beam paths are directed at the projection surface as an image beam pattern (946). The altered beam paths, for example, may be directed to strike one or multiple projection surfaces, similar to the projection surface 712 in FIG. 7A, creating an image or images such as the images 714 and 716 of FIG. 7A.

Returning to FIG. 9A, in some implementations, if the imaging system is configured to use a beam profiler (906) and the beam profiler is disposed before the beam configurator (908). Turning to FIG. 9B, with this configuration, in some implementations, the beam generated by the beam source is directed at the beam profiler (910).

In some implementations, when the imaging system is not using an actuator to produce a beam profile (912), the beam strikes the beam profiler to produce a beam profile (916). The beam profiler, for example, may be similar to the beam profiler 160 of FIG. 1B.

Alternatively, in some implementations where the imaging system uses an actuator (912), the beam profiler is actuated to produce a beam profile (914). The beam profiler may be actuated, for example, in a manner similar to that described in relation to beam profiler 260 and actuation device 250 of FIG. 2A.

In some implementations, the beam profile is directed at the beam configurator (920).

In some implementations, a configured beam profile is produced from the beam configurator with properties according to the configurator settings (922). For example, a beam profile may be incident on, enter, or modified by the beam configurator, creating or emitting the configured beam profile. The configured beam profile may have properties such as, by way of non-exclusive example, wavelength and polarization, determined by the beam configurator controller similar to beam configurator controller 764 of FIG. 7C.

In some implementations, the configured beam profile is directed at the beam diverter (924).

Turning to FIG. 9C, the configured beam profile, in some implementations, is directed at the beam inverter (940) and further follows at least a portion of operations 943, 944 and 946 in the manner discussed above.

Returning to FIG. 9A, in some implementations where the imaging system is configured to use a beam profiler (906), and the beam profiler is disposed after the beam configurator (908), the beam generated by the beam source is directed at the beam configurator (928).

In some implementations, a configured beam is produced from the beam generated by the beam source with one or more properties matching the one or more property settings determined or set by the beam configurator controller (930). The beam, for example, may be incident on, enter, or modified by the beam configurator, creating or emitting the configured beam. The beam configurator may be similar to beam configurator 760 of FIG. 7C. The configured beam may have properties such as, by way of non-exclusive example, wavelength and polarization, determined by the beam configurator controller similar to beam configurator controller 764 of FIG. 7C. The configured beam may be similar to configured beam 762 of FIG. 7C.

In some implementations the configured beam is directed at the beam profiler (932) to produce a configured beam profile.

Turning to FIG. 9C, in some implementations when the imaging system is not using an actuator to produce the configured beam profile (934), the configured beam strikes the beam profiler to produce the configured beam profile (938). The configured beam profile, for example, may be similar to the configured beam profile 726 of FIG. 7C.

Alternatively, in some implementations where the imaging system uses an actuator (934), the beam profiler is actuated to produce a configured beam profile (936). The beam profiler may be actuated, for example, in a manner similar to that described in relation to beam profiler 260 and actuation device 250 of FIG. 2A.

In some implementations the configured beam profile is directed at the beam diverter (940). The beam diverter may be similar to beam diverter 730 of FIG. 7C.

The configured beam profile, in some implementations, is directed at the beam diverter (940) in a manner described above. Further, at least a portion of the operations 942 through 946 may be followed to result in the image beam pattern on the projection surface (946).

Although described in relation to a particular set of operations, in other embodiments, the method 900 may include more or fewer operations. For example, there could be one or more additional lenses, mirrors, or other optical elements to redirect or modify the beam, beam profile, diverted beam profile, altered beam paths, image beam pattern, and/or image. These lenses, mirrors, or other optical elements may or may not be actuated. These elements could serve many purposes, for example such as increasing or decreasing the projector size, increasing or decreasing image size in a given direction, increasing or decreasing image size in multiple dimensions, increasing or decreasing the focus of the image on the projection surfaces, moving the image, moving the image to other projection surfaces, and many other purposes. Further, although described in relation to a particular order of operations, in other embodiments, certain operations of the method 900 may be performed in a different order and/or at least partially concurrently. For example, both a configured beam source and a configurator could be used alternatively or simultaneously to fully configure the beam or beam profile. This could use one or multiple beam diverters. In another example, a beam diverter could be placed before one or multiple beam profilers such that one or multiple beam directors can make one or multiple images. In a further example, multiple beam diverters may be used to create multiple diverted beams and or diverted beam profiles. Other modifications to the method 900 are possible.

While certain embodiments have been described, these embodiments have been presented by way of example only, and are not intended to limit the scope of the present disclosures. Indeed, the novel methods, apparatuses and systems described herein can be embodied in a variety of other forms; furthermore, various omissions, substitutions and changes in the form of the methods, apparatuses and systems described herein can be made without departing from the spirit of the present disclosures. The accompanying claims and their equivalents are intended to cover such forms or modifications as would fall within the scope and spirit of the present disclosures.

What is claimed is:

1. An imaging system, comprising:
a beam source configured to generate a source light beam;
a beam diverter configured to modify at least one property of each light beam of one or more light beams of a beam profile created from the source light beam in accordance with a configuration selection; and
a multiple beam director disposed in a path of the beam profile, the multiple beam director comprising a physical structure including a plurality of surface features configured to modify, based at least in part on the at least one property of each light beam of the one or more light beams of the beam profile, the beam profile to produce at least one encoded image, wherein the multiple beam director is configured to, when the beam profile strikes the multiple beam director,
selectively alter the beam profile according to the at least one property of each light beam of the one or more light beams, thereby producing a light beam image pattern configured to present, upon striking one or more projection surfaces, at least a portion of the at least one encoded image, wherein
the light beam image pattern comprises one or more of a predetermined beam spacing, a predetermined beam size, or a predetermined beam shape.

2. The imaging system of claim 1, further comprising a beam configurator configured to provide, to the beam diverter, a given configuration selection of at least two configuration selections.

3. The imaging system of claim 2, wherein the beam configurator is a controller.

4. The imaging system of claim 3, wherein the beam source comprises the controller.

5. The imaging system of claim 1, wherein the at least one property comprises one or more of a color or a polarization.

6. The imaging system of claim 1, wherein the plurality of surface features comprises at least one of one or more light-scattering surfaces, one or more light-absorbing surfaces, one or more light-reflective surfaces, one or more light-refracting surfaces, or one or more light-diffractive surfaces.

7. The imaging system of claim 1, wherein the plurality of surface features comprises at least one of one or more facets, one or more openings, one or more convex surfaces, or one or more concave surfaces.

8. The imaging system of claim 1, wherein the multiple beam director is maintained in a stationary position relative to the beam source.

9. The imaging system of claim 1, further comprising a beam profiler configured to produce, from the source light beam or a diverted light beam produced by the beam diverter.

10. The imaging system of claim 9, wherein the beam profiler is disposed in the path of the beam diverter.

11. The imaging system of claim 9, wherein the beam source comprises the beam profiler.

12. The imaging system of claim 1, wherein the beam source is configured to project the source light beam directly onto the multiple beam director.

13. The imaging system of claim 1, further comprising at least one image redirection component disposed in a path of at least a first image beam of the light beam image pattern and configured to redirect an angle of output of the at least the first image beam by the imaging system.

14. An imaging system, comprising:
a beam source configured to generate a source light beam;
a beam configuration unit configured to selectively modify at least one property of each light beam of one or more light beams of a beam profile created from the source light beam; and
a beam director unit disposed in a path of the beam profile and comprising a plurality of beam directors, each beam director comprising a physical structure including a plurality of surface features configured to modify, based at least in part on the at least one property of each light beam of the one or more light beams of the beam profile, the beam profile to produce at least one encoded image, wherein
the beam director unit is configured to, when the beam profile strikes the beam director unit, selectively alter the beam profile according to the at least one property of each light beam of the one or more light beams, thereby producing a light beam image pattern configured to present, upon striking one or more projection surfaces, at least a portion of the at least one image, wherein
the light beam image pattern comprises one or more of a predetermined beam spacing, a predetermined beam size, or a predetermined beam shape.

15. The imaging system of claim 14, wherein:
the imaging system comprises one or more input elements; and
the beam configuration unit selectively modifies the at least one property based on one or more settings provided via one or more input elements.

16. A method for generating and emitting an image for projection on at least one projection surface, the method comprising:
providing an imaging apparatus, the imaging apparatus comprising
a beam source,
a beam configuration unit,
a beam diverter, and
two or more beam directors;
determining, by the beam configuration unit, one or more beam property settings;
generating a source light beam with the beam source;
producing, by the imaging apparatus with the source light beam, a beam profile having properties matching the one or more beam property settings;
creating, by striking the beam diverter with the beam profile, a diverted beam profile;
directing, based on one or more diverted beam properties of the diverted beam profile, the diverted beam profile toward an intended beam director of the two or more beam directors;
creating, by striking the intended beam director with the diverted beam profile, one or more altered beam paths; and
directing, by the imaging apparatus, the one or more altered beam paths at one or more projection surfaces of the at least one projection surface as an image beam pattern.

17. The method of claim 16, wherein:
a multiple beam director element comprises the two or more beam directors; and
directing the diverted beam profile toward the intended beam director comprises directed the diverted beam profile via a first beam director path of multiple beam director paths of the multiple beam director element.

18. The method of claim 16, wherein determining the one or more beam property settings comprises receiving at least one of the one or more beam property settings from a beam source controller.

19. The method of claim 16, wherein producing the beam profile comprises directing the source light beam at a beam profiler.

20. The method of claim 16, wherein the beam source maintains a stationary position relative to the beam configuration unit, the beam diverter, and the two or more beam directors.
